(19) United States
(12) Patent Application Publication
(10) Pub. No.: US 2026/0235177 A1
(43) Pub. Date: Aug. 13, 2026

(54) BRAKE DRUM; DRUM BRAKE AND VEHICLE

(71) Applicant: MAHLE International GmbH, Stuttgart (DE)

(72) Inventor: Christoph Steinmetz, Walheim (DE)

(21) Appl. No.: 19/533,071

(22) Filed: Feb. 6, 2026

(30) Foreign Application Priority Data
Feb. 7, 2025 (DE) 102025104634.4

(51) Int. Cl. F16D 65/827; F16D 51/00; F16D 65/00; F16D 65/10

(52) U.S. Cl. CPC F16D 65/827; F16D 65/0025; F16D 65/10; F16D 51/00

(57) ABSTRACT

A brake drum for a drum brake is disclosed. The brake drum includes a carrier pot defining a central axis, which has a pot base aligned transversely to the central axis, a pot wall surrounding the central axis that is arranged integrally on an edge of the pot bottom, and a pot volume. At least one ventilation opening is arranged on the carrier pot, which opens into the pot volume and, together with the pot volume, delimits an air path for an air flow, through which air can flow for cooling the brake drum.

### CROSS-REFERENCE TO RELATED APPLICATIONS

This application claims priority to German Patent Application No. DE 102025104634.4, filed on Feb. 7, 2025, the contents of which is hereby incorporated by reference in its entirety.

### TECHNICAL FIELD

The present invention relates to a brake drum for a drum brake. The invention further relates to a drum brake with such a brake drum and a vehicle having at least one such drum brake.

### BACKGROUND

A brake drum of a drum brake of the type mentioned above is known from publication EP 2 725 256 A1. It comprises a carrier pot in which two brake shoes of the drum brake are arranged, which are designed to interact with the carrier pot in a friction-locking manner in order to generate a braking torque. The brake shoes each have a suction opening that opens onto a friction surface, through which particles, in particular brake dust, which form and accumulate in the carrier pot during normal operation of the drum brake, can be sucked out of the carrier pot.

The task of the invention is to provide an improved or at least different embodiment of a brake drum compared to the prior art described above. Furthermore, an improved drum brake and an advantageous vehicle are to be specified.

In the present invention, these tasks are solved by the subject matter of the independent claim(s). Advantageous embodiments are the subject of the dependent claims, the description, and the drawings.

### SUMMARY

The task is solved by a brake drum for a drum brake, in particular for a vehicle, comprising a carrier pot defining a central axis, which has a pot base aligned transversely to the central axis, a pot wall surrounding the central axis, which is arranged integrally at one edge of the pot base, and a pot volume delimited by the pot base and the pot wall. It is essential to the invention that at least one ventilation opening is arranged on the carrier pot, which opens into the pot volume, wherein the at least one ventilation opening and the pot volume delimit or define an air path for an air flow which, in particular during normal operation of the brake drum or drum brake, can be flowed through by the air flow for cooling the brake drum. The at least one ventilation opening can advantageously be arranged at the pot base. An alternative or additional arrangement of at least one or at least one further ventilation opening on the pot wall is at least conceivable.

The air flow through the at least one ventilation opening and the pot volume, for example during normal operation of the drum brake, enables the components of the drum brake, in particular the air-flushed brake drum of the drum brake, to be cooled. As a result, the drum brake heats up less and, in particular, less quickly, such that undesirable overheating of the drum brake is avoided or at least delayed, thereby avoiding the risk of a reduction in the braking effect of the drum brake, which is regularly associated with such overheating.

The carrier pot may preferably be produced by casting. In particular, the carrier pot may be designed as a cast component, in particular as an aluminum cast component or as a gray cast component. In other words, the carrier pot may be monolithic. The carrier pot could also be forged.

Furthermore, an inner wall surface of the pot wall, which is arranged on an inner circumference of the pot wall and oriented radially inward, can be configured to interact with the brake shoes of the drum brake in a friction-locking manner when the drum brake is actuated in order to generate a braking torque.

In a preferred embodiment of the invention, the at least one ventilation opening may have a round, in particular circular, opening cross-section. This means that the at least one ventilation opening can be created, for example, by inexpensive mechanical processing of the carrier pot, in particular by means of a through hole, or it can be cast into the carrier pot during casting. However, the at least one ventilation opening is not limited to such an opening cross-section. The at least one ventilation opening could also have a slit-like or angular opening cross-section.

In a further preferred embodiment of the invention, it may be provided that the at least one ventilation opening passes through the carrier pot, in particular the pot base, in a first direction aligned parallel to the central axis. Furthermore, a plurality of ventilation openings may be provided in the pot base. These may be distributed in a circumferential direction around the central axis, in particular evenly and/or axially symmetrical with respect to the central axis.

Furthermore, it may be advantageous if, in addition to the aforementioned at least one ventilation opening, a centric hub opening for a hub and/or mounting openings for securing the brake drum to the hub are arranged at the pot base. It is advantageous if the pot base has a mounting section for the hub in which the centric hub opening and the mounting openings are arranged. The mounting section may have a mounting surface aligned transversely, in particular orthogonally, to the central axis for attaching the hub, wherein a radial extension of the mounting section is defined by the radial extension of the mounting surface. In this case, it is advantageous if the at least one ventilation opening is arranged radially outside the mounting section in a section of the pot base connecting the mounting section to the edge of the pot base.

It may also be expedient to provide that the brake drum has a separator for separating solid and/or fluid contaminants from the air flow, which is assigned to the at least one ventilation opening and/or arranged on the carrier pot. The proposed separation device can efficiently prevent or at least significantly reduce the ingress of fluid and/or solid contaminants, in particular water and/or particles, into the pot volume. This prevents unwanted contamination of the brake drum or drum brake.

It may be expedient to provide that the separation device is integrally arranged on the carrier pot or fixed to the carrier pot, in particular by a non-positive connection or in a material-locking manner, in particular clamped or welded or soldered. The separator may have at least one separating element that is configured to separate solid and/or fluid contaminants from the air flow. Furthermore, the air path may be guided through the at least one separating element such that the at least one separating element can be flowed through by the air flow. In doing so, it may be inserted in sections or completely into the at least one ventilation opening. Furthermore, the separator may comprise a ring disc element which is configured to separate solid and/or fluid contaminants from the air flow and/or to serve as a carrier for the at least one separating element. The ring disc element can be arranged on an axial front side of the pot base opposite the pot volume, in particular by a non-positive connection or in a material-locking manner, in particular clamped or welded or soldered or glued. The ring disc element and the at least one separating element can be designed as integral or separate components.

The at least one separating element and/or the ring disc element can preferably be made of a light metal material such as aluminum or an aluminum alloy or a temperature-resistant plastic. At least one separating element itself can be cast or forged or, in the case of a plastic part, manufactured by injection molding, pressing, vacuum casting, or 3D printing.

In particular, the at least one separating element may comprise or be formed by a baffle plate arranged in the air path (i.e., around which the air flow can flow) and/or oriented transversely to the air path. The baffle plate enables the solid and/or fluid contaminants carried in the air flow to be separated by their impingement on the baffle plate. Alternatively or additionally, it may be provided that the at least one separating element has a hollow cylindrical baffle cup arranged in the air path (i.e., through which the air flow can pass), which has a baffle base oriented transversely to the air path with at least one through-opening through which the air path passes, and a circumferential baffle wall arranged on the baffle base. The baffle base enables solid and/or fluid contaminants carried along in the air flow to be separated by impinging against the baffle base.

The baffle plate and the baffle cup can be designed integrally or as separate components. It is also conceivable that the carrier pot and the baffle plate and/or the baffle cup are designed as integral or separate components. It may be provided that the baffle plate is arranged completely or at least in sections in a cup volume delimited by the baffle cup. In this case, the baffle plate is preferably arranged upstream of the baffle base with respect to the air flow. Furthermore, the baffle plate may have a circular, in particular flat, and preferably dome-shaped plate body. The baffle plate and the at least one through-opening may, when viewed in the first direction, overlap each other completely or at least in sections and/or have an axial distance between them. The baffle wall of the baffle cup can enclose or surround the air path, in particular coaxially. Furthermore, the baffle wall can be designed to be conical, in particular conical, or as a straight hollow cylinder. Furthermore, it can be provided that the baffle base of the baffle cup is designed to be flat or conical. The at least one through-opening of the baffle base may be the only through-opening of the baffle base and/or may be centrally located on the baffle base. This allows contaminants, in particular water and/or particles, to be efficiently removed from the air flow and, in particular, facilitates the drainage of the contaminants.

The baffle cup can be inserted into the at least one ventilation opening such that the baffle base of the baffle cup is arranged in the pot volume and/or the baffle wall of the baffle cup is supported, and in particular fixed, in sections on an inner circumference of the at least one ventilation opening. This enables a preferred arrangement of the baffle cup on the carrier pot. It is also conceivable that the baffle cup is fixed, in particular by a non-positive connection or in a material-locking manner, to the carrier pot of the brake drum or the ring disc element of the separator, in particular clamped or welded or soldered or glued, or integrally molded.

Furthermore, it may be provided that the baffle plate has at least one integral connecting web, preferably two, three, four, or more connecting webs, via which the baffle plate is fixed, in particular by a non-positive connection or in a material-locking manner, to the carrier pot of the brake drum or to the baffle cup, in particular the baffle wall of the baffle cup, or the ring disc element of the separator, in particular clamped or welded or soldered, or integrally molded. The two, three, four or more connecting webs arranged on the baffle plate may be arranged symmetrically distributed on the baffle plate. Furthermore, the at least one connecting web or the two, three, four or more connecting webs may be designed to be flat, i.e., in particular lie in a plane orthogonal to the air path. Furthermore, the two, three, or four connecting webs may be bent with respect to the air path, for example, they may be bent with the air flow or against the air flow, and in particular may be convex or concave. This allows contaminants, in particular water and/or particles, to be efficiently removed from the air flow and, in particular, facilitates the drainage of the contaminants.

It may be provided that the at least one separating element has a support ring, via which the at least one separating element is supported, in particular fixed, on the carrier pot. It is advantageous if the baffle plate has at least the said connecting web, preferably the said two, three, four or more connecting webs, and is fixed to the support ring, in particular by a non-positive connection or in a material-locking manner, in particular clamped or welded or soldered, via the at least one connecting web. Furthermore, the support ring can be arranged, in particular fixed in a supporting manner, on the axial front side of the pot base opposite the pot volume. The support ring can be clamped or welded or soldered to the carrier pot in particular.

In an alternative embodiment of the invention, the ring disc element may be arranged on the axial front side of the pot base opposite the pot volume and fixed to the carrier pot, wherein it is arranged at least in the area of the at least one ventilation opening at a distance (in the direction of the central axis) from the axial front side of the pot base, so that (in the direction of the central axis) a gap through which air flow can occur is defined or delimited between the ring disc element and the axial front side of the pot base. According to the invention, the ring disc element axially covers the at least one ventilation opening such that solid and/or fluid contaminants carried along in the air flow are separated from the air flow by impingement with the ring disc element. The gap size, i.e., the distance between the ring disc element and the axial front side of the pot base, can be defined by structures such as ribs arranged on the ring disc element. Furthermore, the ring disc element can be designed in a pot-like manner and extend axially over the carrier pot, at least in sections.

The task mentioned at the beginning is further solved by a drum brake, in particular for a vehicle, comprising a brake drum as described above and a pair of brake shoes, preferably arranged in the pot volume, for friction-locking interaction with one or the said inner wall surface of the pot wall of the brake drum.

The drum brake may optionally have a brake carrier plate which closes an axial pot opening in the carrier pot, preferably opposite the axial front side of the pot base. The brake carrier plate may have a suction nozzle for arranging a connecting device for transporting the air flow, in particular a suction-resistant hose, to a suction fan that provides the air flow.

The brake shoes may each have a brake lining on the side of the brake shoe facing the inner wall surface. The drum brake may have a mechanism for adjusting the brake shoes, for example a brake cylinder for adjusting the brake shoes from a home position to a braking position where they rest against the inner wall surface, and/or a return device, in particular a return spring, for adjusting the brake shoes from the braking position to the home position.

The task mentioned at the beginning is also solved by a vehicle having at least one drum brake as described above, a suction fan for providing the air flow, in particular an ambient air flow, a connecting device for transporting the air flow, in particular a suction-resistant hose, via which the drum brake is connected to the suction fan.

The suction fan can be implemented by a pump, in particular a vacuum pump, or alternatively by a venturi nozzle driven by the airflow.

The term “welded” used in the above description can mean that the components in question are joined together in a material-locking manner, in particular friction stir welding, electron beam welding, or press welding. The term “soldered” used in the above description may mean that the components in question are joined together in a material-locking manner.

Other important features and advantages of the invention can be seen from the dependent claims, from the drawings and from the associated description of the figure based on the drawings.

It is understood that the above-mentioned features and those yet to be explained below can be used not only in the combination indicated in each case, but also in other combinations or on their own, without deviating from the scope of the present invention. The above-mentioned components of a superordinate unit, such as a device, an apparatus, or an arrangement, which are designated separately, can form separate parts or components of this unit or be integral regions or sections of this unit, even if this is shown differently in the drawings.

Preferred exemplary embodiments of the invention are shown in the drawings and are explained in more detail in the following description, wherein identical reference numerals refer to identical or similar or functionally identical components.

### BRIEF DESCRIPTION OF THE DRAWINGS

The drawings, each schematically, show:

FIGS. 1 and 2 illustrate a first embodiment of the brake drum according to the invention,

FIGS. 3-5 illustrate a second embodiment of the brake drum according to the invention with a separator,

FIGS. 6-8 illustrate various methods for connecting, in a material-locking manner, the separator of the brake drum from FIG. 3-5 to a carrier pot of the brake drum,

FIGS. 9-11 illustrate various embodiments of the separating element of the separator device shown in FIGS. 3-5,

FIGS. 12-14 illustrate a third embodiment of the brake drum according to the invention with a separator,

FIGS. 15-17 illustrate various methods for connecting, in a material-locking manner, the separator of the brake drum from FIG. 12-14 to a carrier pot of the brake drum,

FIGS. 18-21 illustrate further different embodiments of a separating element of the separator,

FIG. 22 illustrates a fourth embodiment of the brake drum according to the invention with a separator,

FIG. 23 illustrates a separator from FIG. 22 in a sectional view, a top view and a perspective view, and

FIGS. 24-27 illustrate each a section of the brake drum from FIG. 22 with a separating element.

### DETAILED DESCRIPTION

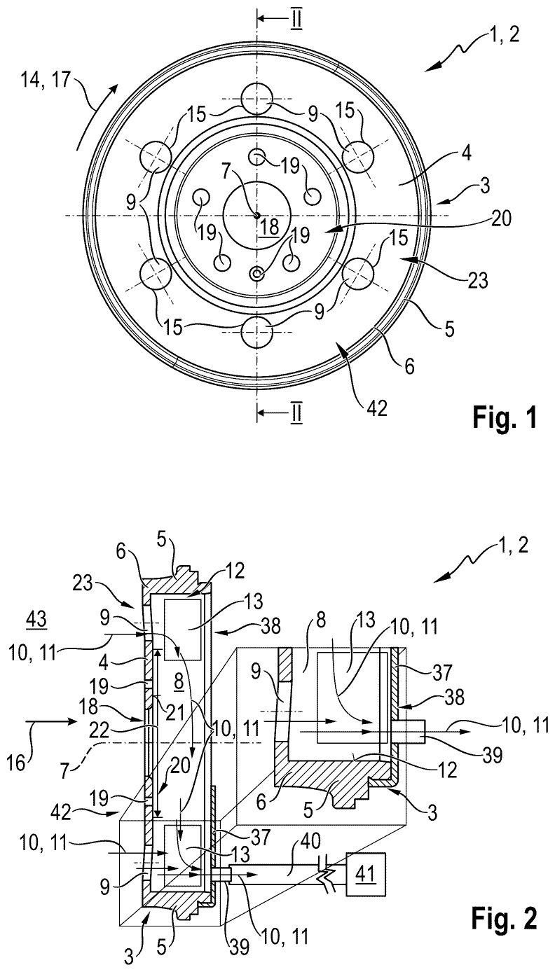

FIGS. 1 and 2 show a brake drum 1 for a drum brake 2 according to a first embodiment, which is shown in FIG. 1 in a top view and in FIG. 2 in a sectional view along a line II-II marked in FIG. 1.

The brake drum 1 has a monolithic carrier pot 3 defining a central axis 7, which is produced, for example, by a casting process. In particular, it can be designed as a cast component, in particular as an aluminum cast component, or as a gray cast iron component. The carrier pot 3 has a pot base 4 aligned transversely to the central axis 7 and a pot wall 5 completely surrounding the central axis 7, which is arranged integrally (i.e., as one piece) on an edge 6 of the pot base 4. The pot base 4 and the pot wall 5 delimit a pot volume 8. It can also be seen that the carrier pot 3 has an axial pot opening 38 defined by an axial end of the pot wall 5, which in this case is closed by a brake carrier plate 37 of the drum brake 2, which is only shown in sections in FIG. 2. The brake carrier plate 37 is conveniently arranged on the pot wall 5. The brake carrier plate 37 can also axially surround the pot wall 5 to improve the connection. Preferably, the brake carrier plate 37 can be rigidly connected to a wheel carrier of a vehicle and/or seal the pot volume 8 of the brake drum 1 against an environment 43, for example in the form of a labyrinth seal.

FIGS. 1 and 2 further show that the pot wall 5 of the carrier pot 3 has an inwardly oriented inner wall surface 12 on its inner circumference, which surrounds the central axis 7 and interacts, in a friction-locking manner, with brake shoes 13 of the drum brake 2, symbolized by simple boxes in FIG. 2 and arranged within the pot volume 8, when the drum brake 2 is actuated, in order to generate a braking torque 14 acting in a circumferential direction 17 rotating around the central axis 7.

Furthermore, it is envisaged that the carrier pot 3 has a centric hub opening 18 at the pot base 4 for a hub not shown here, for example a vehicle hub, and a plurality of mounting openings 19 arranged uniformly in the circumferential direction 17 for securing the brake drum 1 to said hub by means of fastening screws, which are also not shown. A mounting section 20 for the hub is provided at the pot base 4 of the pot, in which the centric hub opening 18 and the mounting openings 19 are arranged. In this case, mounting section 20 has a mounting surface 21 aligned transversely, in particular orthogonally, to the central axis 7 for attaching the hub, wherein a radial extension of mounting section 21 is defined by the radial extension 22 of mounting surface 21.

In order to prevent or at least delay undesirable overheating of the drum brake 2 when it is applied, the present invention provides for several ventilation openings 9 to be arranged on the pot base 4 of the carrier pot 3, each of which opens into the pot volume 8. The ventilation openings 9 and the pot volume 8 limit or define an air path 10 for an air flow 11 consisting of air, in particular ambient air, through which the carrier pot 3 or the drum brake 2 can be flowed through by the air flow 11 during their intended operation.

The air flow 11 passing through the ventilation openings 9 and the pot volume 8 enables efficient cooling of the components of the drum brake 2, in particular the air-flushed brake drum 1 of the drum brake 2. This means that the drum brake 2 heats up less and, in particular, less quickly when activated, such that the maximum operating temperature of the drum brake 2 is reduced and/or undesirable overheating of the drum brake 2 is avoided or at least delayed, thereby avoiding the risk of a reduction in the braking effect of the drum brake 2, which is regularly associated with such overheating.

According to the embodiment illustrated in FIGS. 1 and 2, it is envisaged that the said ventilation openings 9 are arranged radially outside the mounting section 20 of the pot base 4 in a section 23 of the pot base 4 connecting the mounting section 20 to the edge 6 of the pot base 4. The ventilation openings 9 are conveniently arranged evenly in the circumferential direction 17 and axially symmetrically with respect to the central axis 7. Furthermore, the ventilation openings 9 each have a circular opening cross-section 15 and pass completely through the pot base 4 in a first direction 16 aligned parallel to the central axis 7.

It should also be mentioned that the brake carrier plate 37 is equipped with a suction nozzle 39, on which a connecting device 40 for transporting the air flow 11 is arranged, for example a suction-resistant hose. Furthermore, the connecting device 40 is connected, for example, to a suction fan 41 that provides the air flow 11, which is indicated by a box in FIG. 2. The source of the air flow 11 can be, for example, an environment 43.

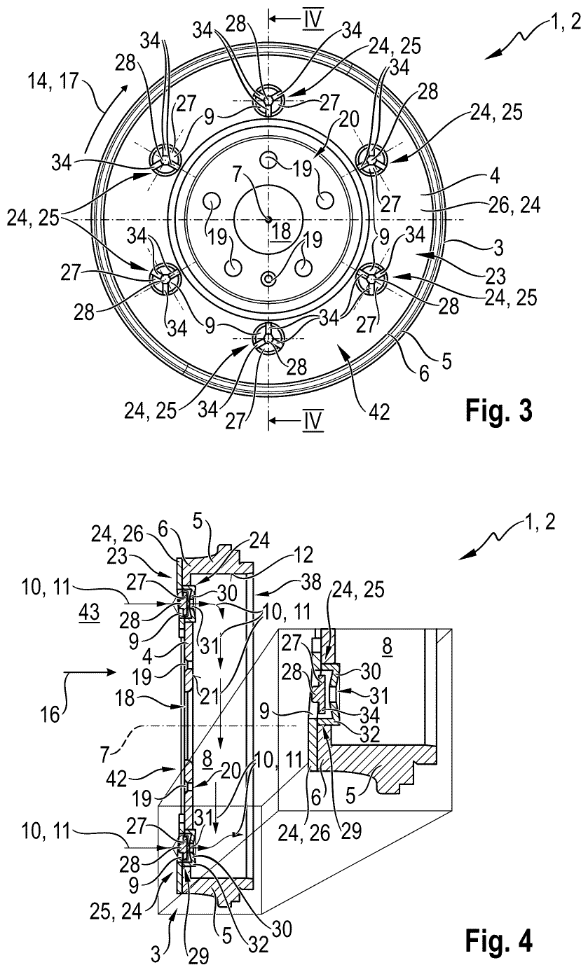

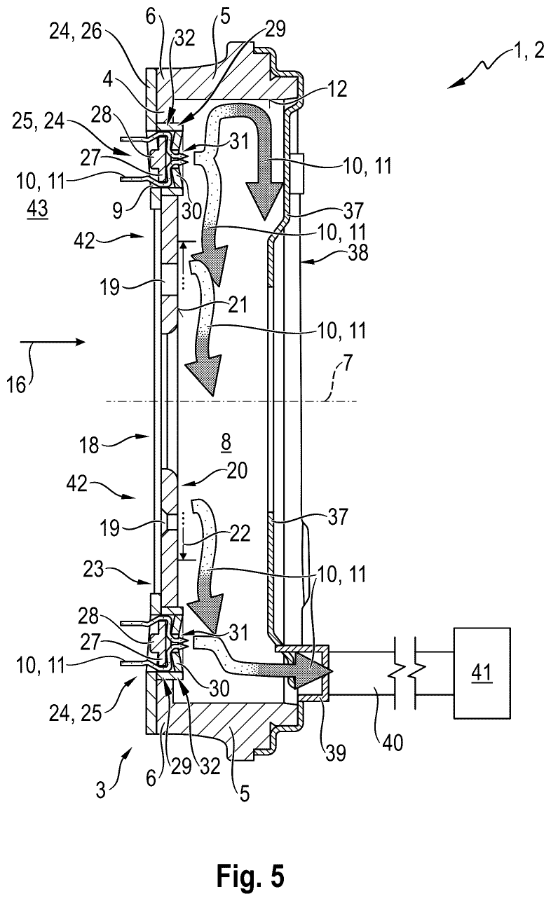

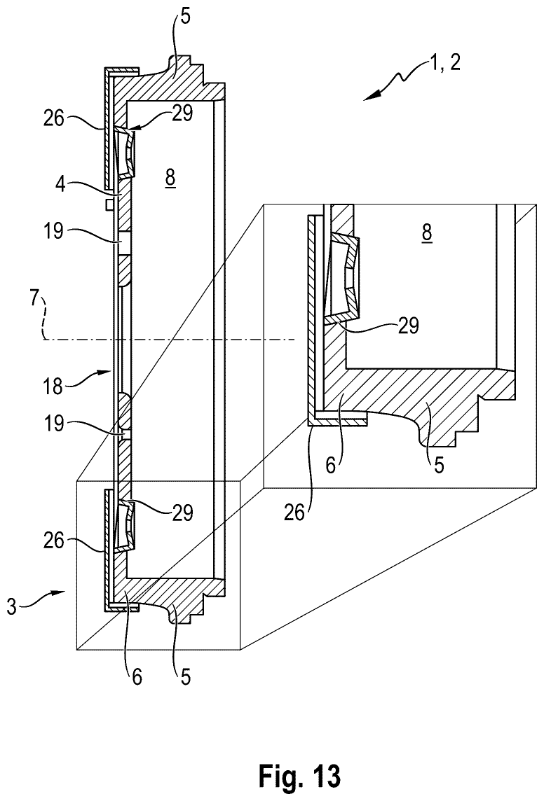

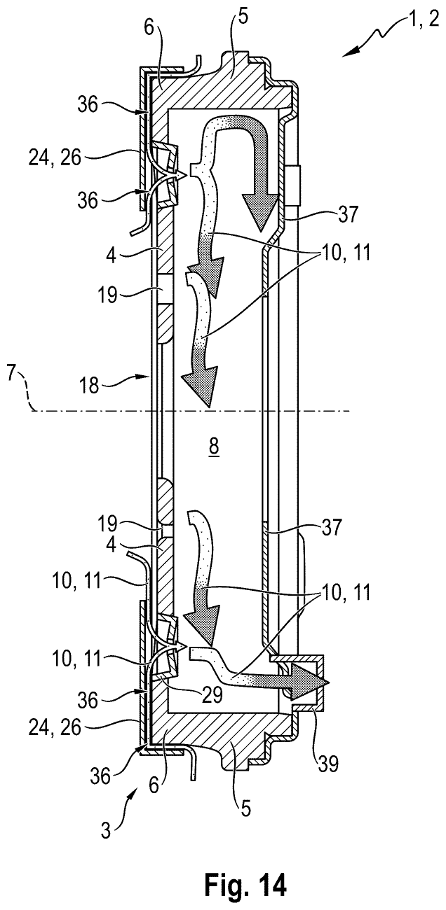

In order to prevent or at least significantly reduce the ingress of liquid and/or solid contaminants from the environment 43, in particular water and/or particles, into the drum brake's pot volume 8 via the ventilation openings 9 during normal operation of the drum brake 2, a separation device 24 for separating solid and/or fluid contaminants from the air flow 11 is proposed, which is assigned to the ventilation openings 9 and is illustrated in various embodiments in FIGS. 3 to 27. This efficiently prevents unwanted contamination of the brake drum 1 or the drum brake 2.

The separator 24 illustrated in FIGS. 3 to 5 has a ring disc element 26 which is arranged on an axial front side 42 of the pot base 4 opposite the pot volume 8 and the axial pot opening 38. The separator 24 also has a separating element 25 for each of the ventilation openings 9, which is fixed to the ring disc element 26 and is inserted in sections into a respective ventilation opening 9. The air path 10 is guided through the ring disc element 26 and the separating elements 25.

Furthermore, FIGS. 3 to 5 show that the separating elements 25 each have a baffle plate 27 arranged in the air path 10 and oriented transversely to the air path 10, wherein the baffle plates 27 enable separation of the solid and/or fluid contaminants carried along in the air flow 11 by their impingement on the baffle plates 27. The separating elements 25 each also have a hollow cylindrical baffle cup 29 arranged in the air path 10, which has a conical baffle base 30 oriented transversely to the air path 10 with a centric through-opening 31 and a circumferential, conical baffle wall 32 arranged on the baffle base 30, whereby the baffle base 30 enables the separation of solid and/or fluid contaminants carried along in the air flow 11 by impingement against the baffle base 30. In the present case, the baffle plates 27 are each arranged completely within a cup volume delimited by a respective baffle cup 29 and, with respect to the air flow 11, in front of the baffle base 30 of a respective baffle cup 29.

It should also be noted that in the embodiment illustrated here, each of the baffle plates 27 has a central, preferably integral, extension 28 which protrudes above the respective baffle plate 27 and faces the aforementioned air flow 11. Furthermore, connecting webs 34 are arranged on the extensions 28 or the baffle plates 27, via which a respective baffle plate 27, in particular by a non-positive connection or in a material-locking manner, to the carrier pot 3 of the brake drum 1 or to the baffle cup 29, in particular the baffle wall 32 of the baffle cup 29, or the ring disc element 26 of the separator 24.

The connecting webs 34 or the baffle plates 27 and the baffle cup 29 are integrally designed with the ring disc element 26 in the present case. However, it may also be provided that a baffle plate 27 and a baffle cup 29 are each designed as a structural unit and arranged on the carrier pot 3. Furthermore, the baffle plates 27 and the baffle cups 29 can each be designed as separate structural units and arranged on the carrier pot 3.

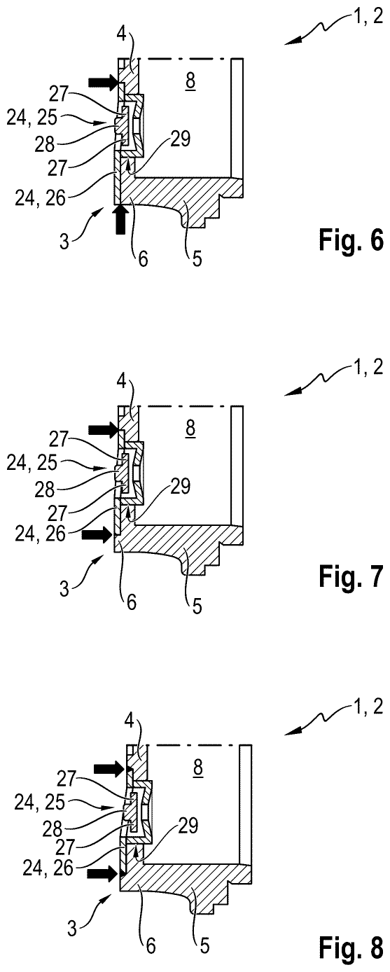

FIGS. 6 to 8 show various methods for joining the ring disc element 26 of the separator 24 of the brake drum 1 to the carrier pot 3 in a material-locking manner. Specifically, FIG. 6 shows electron beam welding, FIG. 7 shows friction stir welding, and FIG. 8 shows arc welding.

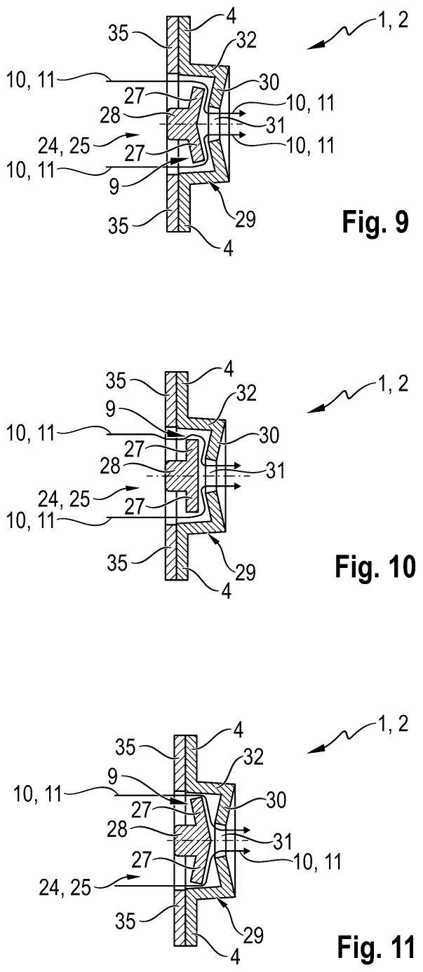

FIGS. 9 to 11 show various embodiments of the separating element 25 of the separator 24 from FIGS. 3 to 5. In contrast to the previous embodiment of the separating element 25, here it is provided that the separating elements 25 each additionally have a support ring 35, via which a respective separating element 25 is fixed to the carrier pot 3. It is advantageous if the connecting webs 34 of a separating element 25 arranged on a baffle plate 27 are fixed to the support ring 35, in particular clamped or welded or soldered. Furthermore, the support ring 35 can be arranged, in particular fixed in a supporting manner, on the axial front side 42 of the pot base 4 opposite the pot volume 8. The baffle plate 27 of the separating element 25 shown in FIG. 9 is bent by the air flow 11, which is also understood here as “convexly bent”. The baffle plate 27 of the separating element 25 shown in FIG. 10 lies in a plane orthogonal to the air path 11. Furthermore, the baffle plate 27 of the separating element 25 shown in FIG. 11 is bent away from the air flow 11, which is also understood here as “concavely bent”.

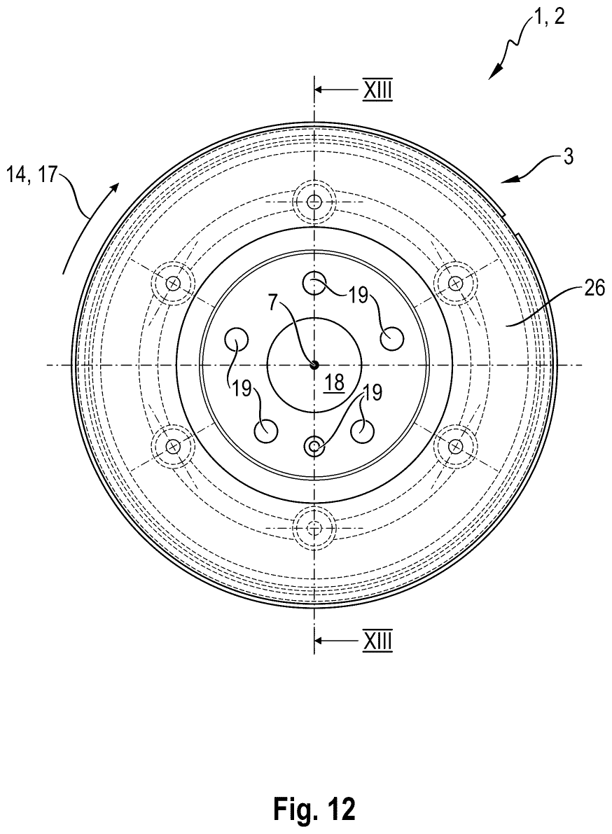

FIGS. 12 to 14 show a third embodiment of the brake drum 1 according to the invention, wherein the separator 24 is formed by the ring disc element 26 and the baffle cups 29. A gap 36 through which the air flow 11 can pass is defined between the ring disc element 26 and the at least one ventilation opening 9 or the pot base 4.

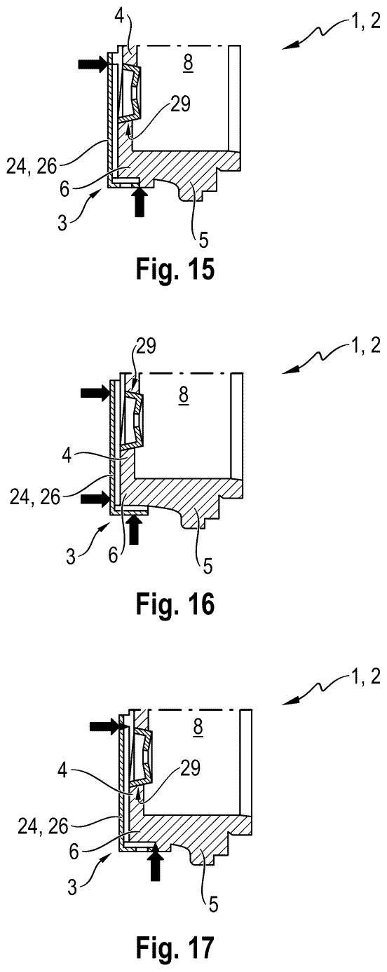

FIGS. 15 to 17 show various methods for permanently joining the ring disc element 26 of the separator 24 of the brake drum 1 from FIGS. 12 to 14 to the carrier pot 3 of the brake drum 1. Specifically, FIG. 15 shows electron beam welding, FIG. 16 shows friction stir welding, and FIG. 17 shows arc welding.

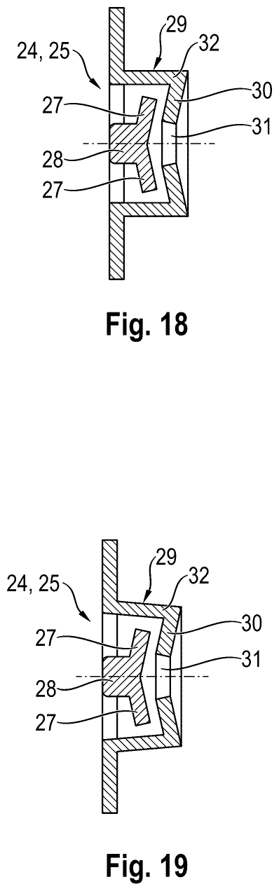

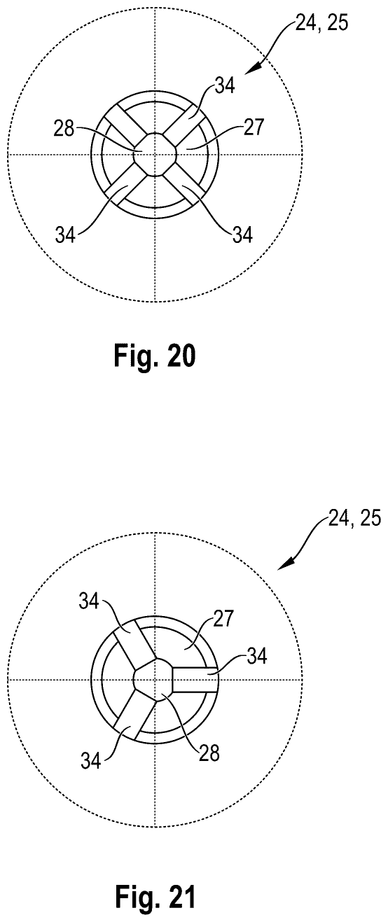

Finally, FIGS. 18 to 21 show separating elements 25 in various embodiments. In FIG. 18, the baffle wall 32 of the baffle cup 29 is specifically designed as a straight hollow cylinder. Furthermore, in FIG. 19, the baffle wall 32 of the baffle cup 29 is designed to be conical, in particular conical. The separating element 25 shown in FIG. 20 has four connecting webs 34, and the separating element 25 shown in FIG. 21 has three connecting webs 34, each of which is connected to a baffle plate 27 via a central extension 28.

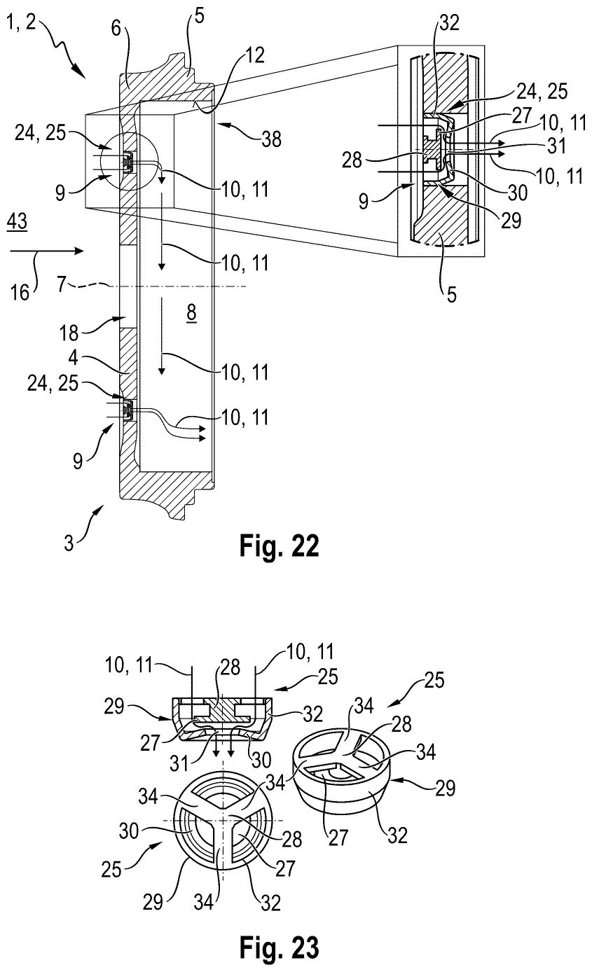

FIG. 22 shows a fourth embodiment of the brake drum 1 according to the invention in a sectional view. It corresponds to the second embodiment of the brake drum 1 according to the invention illustrated in FIGS. 3 to 5, but with the difference that the separator 24 has several separating elements 25, each of which is designed separately. In this case, the separating elements 25 are fully inserted into the ventilation openings 9 of the carrier pot 3, preferably pressed in (ins. press fit), and the air flow 11 flows or can flow through them and are each monolithic, for example. This allows air to flow along the air path 10, again indicated by arrows, through the ventilation openings 9 of the carrier pot 3 and through the separating elements 25 into the pot volume 8 of the carrier pot 3, thereby effecting the desired cooling of the brake drum 1.

Furthermore, FIGS. 22 and 23 show that the separating elements 25 each have a baffle plate 27 arranged in the air path 10 and oriented transversely to the air path 10. The baffle plates 27 again cause the solid and/or fluid contaminants carried along in the air flow 11 to be separated by their impingement on the baffle plates 27. The baffle plates 27 are connected via a central extension 28 with three connecting webs 34 each. The separating elements 25 each also have a hollow cylindrical baffle cup 29 arranged in the air path 10, which has a conical baffle base 30 oriented transversely to the air path 10 with a centric through-opening 31 and a circumferential, conical baffle wall 32 arranged on the baffle base 30. The baffle base 30 enables the solid and/or fluid contaminants carried along in the air flow 11 to be separated by their impingement on the baffle base 30. In the present case, the baffle plates 27 are each arranged completely within a cup volume delimited by a respective baffle cup 29 and, with respect to the air flow 11, upstream of the baffle base 30 of a respective baffle cup 29.

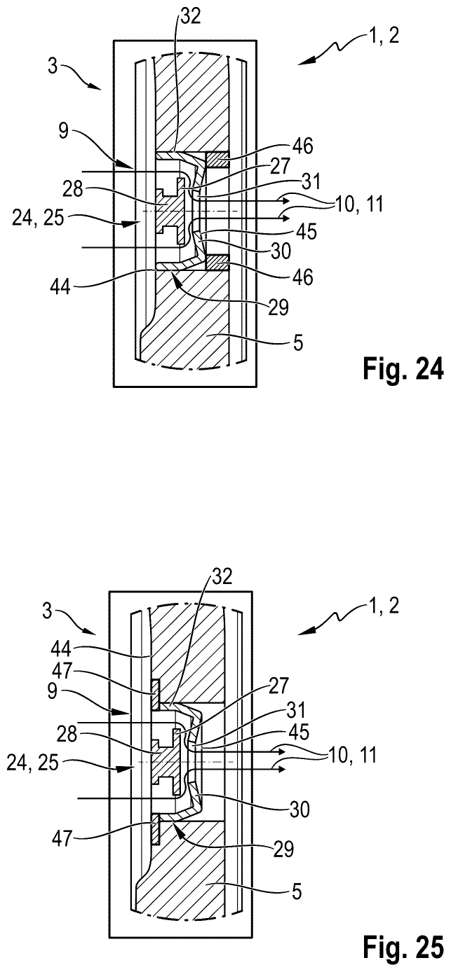

Furthermore, as mentioned above, the separating elements 25 can be designed as monolithic press-fit elements, each of which is pressed into one of the ventilation openings 9 of the carrier pot 3 and is thereby fixed in position on the carrier pot 3. This eliminates the need for an (additional or alternative) material bond between the separating elements 25 and the carrier pot 3. Advantageously, the ventilation openings 9 and/or the separating elements 25 can each be provided with a stop 46, 47, see FIGS. 24 and 25. This allows, in particular, a secure fit to be achieved and/or a press-fit depth of a separating element 25 into a respective ventilation opening 9, i.e., a distance between an opening 44 of the ventilation opening 9, through which a separating element 25 is inserted into the ventilation opening 9, and a front side 45 of the separating element 25.

For example, according to the embodiment illustrated in FIG. 24, the separating elements 25 are designed as press-fit elements, and each ventilation opening 9 has a stop 46 for a separating element 25, for example a pin or a web running around the inner circumference of the ventilation opening 9. This allows the press-in depth of the separating element 25 to be specified by the separating element 25 striking the stop 46 of the ventilation opening 9 when pressed into the ventilation opening 9.

Furthermore, according to the embodiment illustrated in FIG. 25, the separating elements 25 are designed as press-fit elements, and each separating element 25 has an integral stop 47 which serves as a depth stop when the separating element 25 is pressed into a respective ventilation opening 9. The stop 47 of the separating element 25 can, for example, be designed as a circumferential collar or as radial protrusions. This allows the press-in depth of the separating element 25 to be specified by ensuring that, when the separating element 25 is pressed into a ventilation opening 9, the stop 47 of the separating element 25 strikes the ventilation opening 9.

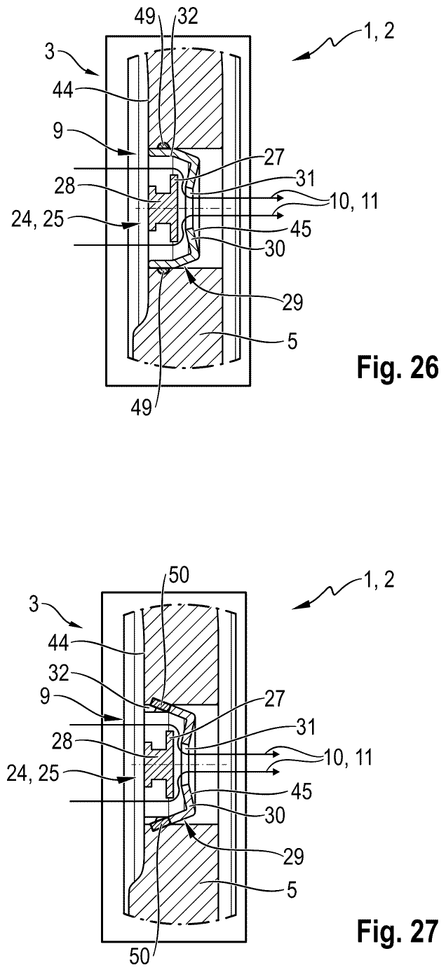

FIGS. 26 and 27 show two embodiments of the separating elements 25 from FIGS. 22 and 23, each of which is inserted into one of the ventilation openings 9 of the support pot 3 and is fixed in place by means of latching elements or clamping elements provided on the separating elements 25 for securing each separating element 25 in a ventilation opening 9, in each case (and in particular exclusively) by clamping to the carrier pot 3. For example, a clamping bead 49 is provided as a clamping element on the separating element 25 illustrated in FIG. 26, and a locking pawl 50 is provided as a locking element on the separating element 25 illustrated in FIG. 27, wherein both the clamping bead 49 and the locking pawl 50 can preferably engage in complementary recesses of the ventilation opening 9. It is understood that the stops 46 of the separating elements 25 and/or stops 47 of the ventilation opening 9 discussed above can also be implemented in the embodiments shown in FIGS. 26 and 27.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments. “One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase “at least one of” followed by successive elements separate by the word “and” (e.g., “at least one of A and B”) is to be interpreted the same as “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

What is claimed is:

1. A brake drum for a drum brake, comprising:
a carrier pot defining a central axis, the carrier pot including a pot base aligned transversely to the central axis, a pot wall surrounding the central axis, is the pot wall arranged integrally on an edge of the pot bottom, and a pot volume delimited by the pot base and the pot wall,
at least one ventilation opening that opens into the pot volume arranged on the carrier pot,
the at least one ventilation opening and the pot volume delimit an air path for an air flow of air, through which the air flow is flowable for cooling the brake drum.

2. The brake drum according to claim 1, wherein the at least one ventilation opening is arranged on the pot base.

3. The brake drum according to claim 1, wherein the at least one ventilation opening has a round opening cross-section.

4. The brake drum according to claim 1, wherein:
the at least one ventilation opening passes through the carrier pot in a first direction aligned parallel to the central axis, and/or
a plurality of ventilation openings are provided on the pot base, the plurality of ventilation openings are arranged in a circumferential direction around the central axis.

5. The brake drum according to claim 1, further comprising a centric hub opening for a hub and/or mounting openings for fixing the brake drum to the hub arranged on the pot base.

6. The brake drum according to claim 1, wherein the at least one ventilation opening is assigned a separator for separating solid and/or fluid contaminants from the air flow.

7. The brake drum according to claim 6, wherein the separator is integrally arranged on the carrier pot or fixed to the carrier pot.

8. The brake drum according to claim 6, wherein:
the separator has at least one separating element that is inserted at least in sections or completely into the at least one ventilation opening and through which the air path leads, and/or
the separator has a ring disc element that is arranged on an axial front side of the pot base opposite the pot volume.

9. The brake drum according to claim 8, wherein:
the at least one separating element is provided and has a baffle plate arranged in the air path and oriented transversely to the air path, wherein the baffle plate facilitates separating the solid and/or fluid contaminants carried along in the air flow by their impingement on the baffle plate, and/or
the at least one separating element is provided and has a hollow cylindrical baffle cup arranged in the air path, the hollow cylindrical baffle cup having a baffle base oriented transversely to the air path with at least one through-opening and a circumferential baffle wall arranged on the baffle base, wherein the baffle base facilitates separation of the solid and/or fluid contaminants carried along in the air flow by their impingement on the baffle base.

10. The brake drum according to claim 9, wherein:
the baffle plate is provided and has at least one integral connecting web via which the baffle plate is connected to the carrier pot or to the baffle cup or the ring disc element of the separation device, and/or
the baffle cup is provide and is fixed to the carrier pot or the ring disc element of the separator.

11. The brake drum according to claim 6, wherein the at least one separating element has a support ring via which the at least one separating element is fixed to the carrier pot.

12. The brake drum according to claim 6, wherein:
the separator has a ring disc element arranged on an axial front side of the pot base opposite the pot volume and is fixed to the carrier pot, wherein the ring disc element is arranged at least in a region of the at least one ventilation opening in a direction of the central axis at a distance from the axial front side of the pot base, such that, in the direction of the central axis, a gap through which the air flow can pass is defined or delimited between the ring disc element and the axial front side of the pot base, and
wherein the ring disc element axially covers the at least one ventilation opening such that solid and/or fluid contaminants carried along in the air flow are separated from the air flow by impingement with the ring disc element.

13. A drum brake, comprising:
a brake drum, the brake drum including:
a carrier pot defining a central axis, the carrier pot including a pot base aligned transversely to the central axis, a pot wall surrounding the central axis, is the pot wall arranged integrally on an edge of the pot bottom, and a pot volume delimited by the pot base and the pot wall,
at least one ventilation opening that opens into the pot volume arranged on the carrier pot,
the at least one ventilation opening and the pot volume delimit an air path for an air flow of air, through which the air flow is flowable for cooling the brake drum, and
brake shoes for interacting, in a friction-locking manner, with an inner wall surface of the pot wall of the brake drum.

14. A vehicle having
at least one drum brake, the at least one drum brake including:
a brake drum comprising:
a carrier pot defining a central axis, the carrier pot including a pot base aligned transversely to the central axis, a pot wall surrounding the central axis, is the pot wall arranged integrally on an edge of the pot bottom, and a pot volume delimited by the pot base and the pot wall,
at least one ventilation opening that opens into the pot volume arranged on the carrier pot,
the at least one ventilation opening and the pot volume delimit an air path for an air flow of air, through which the air flow is flowable for cooling the brake drum,
brake shoes for interacting, in a friction-locking manner, with an inner wall surface of the pot wall of the brake drum;
a suction fan for providing the air flow,
a connecting device via which the drum brake is connected to the suction fan.

15. The vehicle according to claim 14, wherein the connecting device comprises a suction-resistant hose.

16. The drum brake according to claim 13, wherein the at least one ventilation opening includes a plurality of ventilation openings provided on the pot base, the plurality of ventilation openings arranged in a circumferential direction around the central axis and distributed evenly and/or axially symmetrical with respect to the central axis.

17. The drum brake according to claim 13, wherein the at least one ventilation opening is arranged on the pot base.

18. The drum brake according to claim 13, wherein the at least one ventilation opening has a round opening cross-section.

19. The drum brake according to claim 13, wherein the at least one ventilation opening passes through the carrier pot in a first direction aligned parallel to the central axis.

20. The drum brake according to claim 13, wherein the at least one ventilation opening has an associated separator for separating solid and/or fluid contaminants from the air flow.
